(19) United States
(12) Patent Application Publication
(10) Pub. No.: US 2025/0162075 A1
(43) Pub. Date: May 22, 2025

(54) LASER-BEAM WELDING METHOD

(71) Applicant: AUDI AG, Ingolstadt (DE)

(72) Inventors: Daniel BÖHM, Neuenstadt (DE); Jan-Philipp WEBERPALS, Abstatt (DE)

(73) Assignee: AUDI AG, Ingolstadt (DE)

(21) Appl. No.: 18/729,691

(22) PCT Filed: Nov. 28, 2022
(86) PCT No.: PCT/EP2022/083471

§ 371 Date: Jul. 17, 2024

(30) Foreign Application Priority Data
Mar. 21, 2022 (DE) 10 2022 106 540.5

(51) Int. Cl. B23K 26/244; B23K 26/06; B23K 26/067

(52) U.S. Cl. CPC B23K 26/244; B23K 26/0626; B23K 26/0676

(57) ABSTRACT

A method for laser beam welding at least two joint partners which are placed one above the other in a lap joint. The two joint partners are welded to one another by a linear seam to form a preferably closed-surface connection zone. In order to form the connection zone, the laser beam is guided along a target welding track in the welding process according to any path planning strategy, in particular while forming a weld seam path, the adjacent path sections of which build up the preferably closed-surface connection zone.

### FIELD

The invention relates to a laser beam welding method.

### BACKGROUND

The battery system of an electrically powered vehicle consists of several battery modules, which in turn are made up of a large number of individual battery cells. The terminals of the battery cells are interconnected by means of cell connectors (busbars). Both the terminals and the cell connectors can be made of aluminum. In addition to compounds of the same type made of aluminum, combinations with, for example, copper compounds of the same type or mixed compounds can also be used. In the case of round cells, use can also be made of steel with an appropriate coating, such as a diffusion-annealed steel strip with an electrolytic nickel coating. The invention is applicable to the contacting of battery cells of any cell format (namely round cells, prismatic cells or pouch cells).

Laser beam welding technology is used to electrically connect the terminals to the cell connectors. The main requirement for this connection is the electrical contact resistance and the mechanical strength. In order to achieve the lowest possible contact resistance and high mechanical strength, a correspondingly large connection area (hereinafter referred to as large-area connection zone) must be created between the cell connector and the terminal. In addition, the geometry of the weld seam pattern is also crucial for the further optimization of these parameters.

In order to achieve a corresponding high process quality, laser beam oscillation is used in the laser beam welding process known from the prior art. A frequent lateral or circular oscillation (or alternatively any hybrid form thereof, such as a Lissajous figure) is superimposed on a target welding track along which the laser beam is guided. This type of process control is a technology also used in car body construction. During oscillation, the processing optics must usually use scanner mirrors to provide a frequency and amplitude adapted to the feed rate in order to generate a closed connection surface or connection zone.

Due to the inertia of the moving masses of the scanner mirror and the functioning of the drive motors/unit, this amplitude can no longer be achieved as the feed speed and thus the scanning frequency increase. Consequently, the achievable seam width in the joint plane decreases with the amplitude and the requirements for electrical resistance and strength are no longer guaranteed.

In the prior art, the achievable feed rate and thus the productivity of the system is limited by the selected process strategy using beam oscillation.

As previously described, in the prior art, the process speeds cannot be scaled up arbitrarily in order to produce a uniformly strong weld seam connection. The regulation is represented by the scanner system with regard to achievable path fidelity with superimposed beam oscillation (scan frequency and amplitude). Due to the non-continuable scaling, the functionality of the connection (for example resistance and strength) is reduced.

A large seam width can be achieved other than by beam oscillation also by a large focus diameter. Due to their process design, both methods are not suitable for scaling in process speed. The oscillation cannot maintain the required path fidelity in terms of amplitude; the large focus diameters require a very high laser power. Such a high laser power for the large focus diameter leads to overheating of the connection zone and thus to the decomposition of electrically insulating plastic layers and seals.

From DE 10 2013 215 362 A1 a method for determining a welding depth during laser welding is known. A method for producing a joining body is known from DE 10 2010 039 893 A1.

### SUMMARY

The object of the invention is to provide a method for laser beam welding which enables a high process speed and yet a secure weld seam connection with minimal contact resistance and high mechanical strength. At the same time, the limit temperature for the decomposition of electrically insulating plastic layers and seals must not be exceeded.

The invention is based on a method for laser beam welding of at least two joint partners. These are placed on top of each other in a lap joint and are welded together by a linear seam while forming a preferably closed-surface connection zone or connection surface. The closed-surface connection zone forms an electrical contact between the two joint partners. In order to achieve a reduced transition resistance at the connection zone, it is therefore particularly important that the two joint partners in the connection zone are welded together, preferably over a closed surface. According to the characterizing part of claim 1, in order to form the connection zone, the laser beam is guided along a target welding track in the welding process in any path planning strategy, namely to form a weld seam path, the adjacent path sections of which build up the connection zone.

In a preferred embodiment, to which the invention is not limited, the welding process is carried out with a path planning strategy in which the laser beam is guided along a meandering and/or spiral-shaped target welding track.

An increase in the process speed can be achieved in particular by reducing the focus diameter. With a smaller focus diameter, a required welding depth can be achieved with less laser power than with a large focus diameter. At the same time, in order to achieve a required welding depth, the feed rate can be scaled upwards via the laser power (conservation of energy: constant input energy per unit length=laser power per feed rate). However, as a result of the reduced focus diameter, the seam width achievable in the welding process decreases. In order to achieve the required total seam width for the resulting connection surface, according to the characterizing part of claim 1, several track sections of the weld seam path are placed next to one another in order to build up the total seam width. It is important that the welding process should preferably not be interrupted during the generation of the entire weld seam geometry, which has a meander shape, a spiral shape or a combination thereof.

In order to better control the process with an increasing increase of feed rate, a superimposed beam forming is recommended compared to a simple laser beam round spot. On the one hand, this smoothes the seam surface of the generated weld geometry and at the same time influences the track spacing of the individual tracks. With superimposed beam forming, the weld seam can be widened in the flanks, which means that the same seam width can be produced with a smaller number of adjacent tracks. This depends on the power ratio of the radiation surfaces. With regard to direction independence, these are preferably divided into a radially inner circular surface and a radially outer ring or shell surface, which are concentrically aligned with each other, with or without an intermediate geometric gap. The welding depth is created via the inner circle, and the seam width is influenced via the surrounding circular ring.

As a result of the juxtaposition of several tracks/paths, heat accumulates in the welding zone, depending on the weld seam geometry to be welded. This means that the welding depth increases with each pass according to the stored heat. In order to counteract this and achieve a constant welding depth, it is advisable to deliberately reduce the laser power during the construction of the closed-surface connection zone. For example, by lowering the laser power on the subsequent individual track.

An essential core of the invention is that any target weld seam geometries can be generated to ensure a resistance and strength-optimized welding connection of a high-voltage battery cell contact that is adapted to the overall system. The continuous increase in the feed rate is only subject to the available power, whereby the feed rate can be increased as required. This allows the resulting total time for producing a weld to be reduced many times over compared to the approaches described in the prior art.

In addition to the electrical cell contacts described, for example, made of preferably aluminum or copper or a mixed compound or of steel (for round cells), this idea can also be applied to other weld seams in the drive train, power electronics or body construction. The advantages of the invention lie in particular in the increase in process speed during laser beam welding of materials with small focus diameters to generate a weld seam connection by placing individual tracks next to each other.

To determine the beam geometry, a balanced compromise must be defined between focus diameter, beam forming, intensity distribution and feed rate. As indicated above, a small focus diameter is advantageous for achieving high speeds. Superimposed beam forming helps to adjust the ratio of the seam width to the welding depth as well as to smooth the seam surface.

The beam forming can take place by adapting or increasing optical components in the equipment strand in the laser beam source, via the beam guidance in the glass fiber or directly in the processing optics. The design of the optical elements describes the geometry of the beam arrangement. To ensure that the surface can be machined in as many directions as possible, they are preferably arranged concentrically. The superimposed power distribution (intensity=power/area) can take place individually before and/or during the processing process using the applied beam forming principle. In addition to a round design of the beams, other shapes such as ellipses, rectangles, or combinations thereof can also be used. In addition to fibers, all beam configurations can be generated by optical elements such as a prism, a diffractive or refractive optical element or other characteristics in the processing optics, preferably in the collimated beam path between the collimating lens and the focusing lens.

A small seam width in the welding plane results in a very long weld seam to create the required connection zone. In order to minimize this seam length, the entire seam length is projected onto a defined (e.g. meandering and/or spiral-shaped) weld seam geometry and built up by adjoining/winding up the seam side by side. One possible strategy is to form a target welding track in meander shape, which has any number, for example five, of longitudinal track sections placed next to each other (the individual length of which is determined by the required weld geometry), which are connected with, for example, right-angled connections.

Alternatively, the connections can be semicircular or have any other geometry. The number of longitudinal track sections depends on the required seam width (1 . . . n). The respective track spacing is constant and is determined depending on the individual track width. For example, a track spacing of 0.5 mm can be set, which ensures an overlap with a single seam width of 0.55 mm, for example. By choosing the image of the processing optics, the fiber diameter, the beam forming, the power and the feed, the track spacing can be individually determined and is an adaptable scaling variable.

When welding with a constant laser power, a heat field is formed depending on the weld geometry, which leads to a corresponding accumulation. Consequently, this preheating leads to a greater welding depth in the subsequent track. In order to counteract this heat build-up-related increase in the welding depth and the simultaneous overall increase in the temperature in the joint connection, it is advisable to reduce the laser beam power for each individual track. For example, the laser beam power per individual track can be reduced by a predefined amount. This reduction in power depends on the length and geometry of the tracks and thus on the resulting heat field. This is directly related to the process parameters.

The flexibility of the scanner allows the weld seam geometries to be constructed using all conceivable path planning strategies. Symmetrical welding track shapes, such as a meander or a spiral, are preferred. The spiral can be designed in any geometry. Preferably, the spiral can be rectangular with mutually parallel longitudinal track sections. Alternatively, the spiral can extend radially from the inside in a circular pattern with a continuously increasing radius to the outside.

In the following, aspects of the invention are highlighted again in detail: The preferably closed-surface connection zone can be formed with exactly one weld seam path that extends uninterruptedly along the entire target welding track. Alternatively, the target welding track can also be placed with interruptions if, for example, two seam regions are built up alternately in one geometry or adjacent geometries. In addition, the cell contact between the cell terminal and the cell connector can also be formed, for example, by two or more independent connection zones. In this case, each connection zone can be assigned a weld seam geometry with, for example, an uninterrupted target welding track.

It is preferred if the laser beam is guided along the target welding track during the welding process without any superimposed oscillating pendulum movement. In this case, the path traveled by the laser beam on one of the joint partner surfaces corresponds to the length of the target welding track. In contrast, the prior art involves a local and/or temporal laser beam oscillation, in which the laser beam crossing along the target welding track is superimposed on a frequent lateral or circular oscillation (or alternatively any hybrid form thereof, such as a Lissajous figure). In this case, the path traveled by the laser beam is considerably longer than the actual length of the target welding track. During laser beam oscillation, the processing optics in the laser beam welding device must be operated via a scanner mirror at a frequency and amplitude adapted to the feed rate in order to generate the closed-surface connection zone. Due to the inertia of the moving masses of the scanner mirrors and the functioning of the drive motors/unit, this amplitude cannot be reached anymore when the feed speed and thus the scan frequency is increasing. As a result, the feed rate is limited with regard to the inertia of the processing optics (scanner mirror).

In view of a perfect weld seam geometry, the setting of an appropriate track spacing between adjacent track sections of the target welding track is important. It is preferred if the track spacing is dimensioned such that the corresponding path sections of the weld seam path formed in the welding process overlap with a lap amount.

As mentioned above, a small focus diameter in particular leads to a correspondingly reduced seam width of the weld seam path. In order to increase the seam width on the weld seam surface, it is preferred if beam forming is carried out in which the laser beam is divided into at least a first partial beam and a second partial beam, each of which has a different power per radiation area.

With a view to achieving laser beam processing that is as direction-independent as possible, it is preferred if a radially inner core beam and a concentric, radially outer ring beam with or without an intermediate geometric gap are generated by means of beam forming. In this case, the power distribution between the core and ring beam can be dimensioned such that the welding depth is adjusted by means of the core beam and the seam width is adjusted by means of the ring beam.

In a specific design variant, the laser beam power can be reduced in a targeted manner as the welding process progresses while the closed-surface connection zone is being built up. Such a reduction in laser beam power counteracts an increase in welding depth and process temperature caused by heat build-up. Preferably, for example, when forming each adjacent path section of the weld seam path, the laser beam power can be reduced by a predefined amount.

According to the invention, the target welding track can run in any shape in order to form the closed-surface connection zone. According to a first embodiment variant, the target welding track can be designed in a meandering shape with longitudinal track sections parallel to one another. The longitudinal track sections can be connected in series via transverse track sections. The transverse track sections can have any geometry. For example, the transverse track sections can be designed to be straight, thereby providing a right-angled connection between adjacent longitudinal track sections. Alternatively, the transverse track sections can be circular or curved.

For example, in the welding process, the laser beam power can be reduced by a predefined amount for each longitudinal track section during the laser beam passage in the order from the first longitudinal track section to the last longitudinal track section.

In an alternative embodiment, the target welding track can have a spiral shape in which the target welding track extends spirally from a radially inner starting point to the radially outward in a circular movement sequence with a continuously increasing radius of movement. In a further alternative design variant, the target welding track can be designed in a hybrid form of spiral shape and meander shape. In this case, the target welding track can have a radially inner longitudinal track section as well as further longitudinal track sections arranged parallel to both sides thereof. All longitudinal track sections are connected to each other in a spiral via transverse track sections.

### BRIEF DESCRIPTION OF THE FIGURES

Exemplary embodiments of the invention are described in the following on the basis of the appended figures. In particular:

FIG. 1 shows a welded joint between two metallic joint partners with partial section;

FIG. 2 shows a laser beam welding device for producing the welded joint in FIG. 1;

FIG. 3 shows a view of an embodiment of the invention;

FIG. 4 shows a view of an embodiment of the invention;

FIG. 5 shows a view of an embodiment of the invention;

FIG. 6 shows a view of an embodiment of the invention;

FIG. 7 shows a view of an embodiment of the invention;

FIG. 8 shows a view of an embodiment of the invention;

FIG. 9 shows a view of an embodiment of the invention;

FIG. 10 shows a view according to a comparative example not covered by the invention;

FIG. 11 shows a view according to a comparative example not covered by the invention.

### DETAILED DESCRIPTION

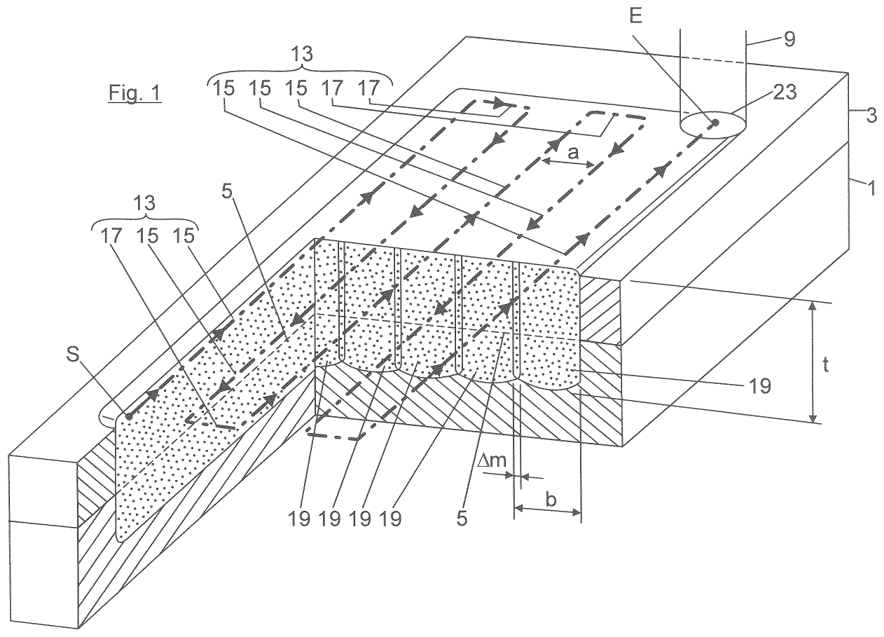

FIG. 1 shows a component arrangement consisting of two joint partners 1, 3, which are placed on top of each other in a lap joint and welded together by a linear seam. Between the two joint partners 1, 3, a closed-surface connection zone 5 is formed, in which the two joint partners 1, 3 are welded together. Preferably, the lower joint partner 1 can be a cell terminal of a battery cell of a high-voltage battery system of a vehicle, while the upper joint partner 3 is part of an electrical cell connector. The closed-surface connection zone 5 forms an electrical contact between the two joint partners 1, 3. It is important that the two joint partners 1, 3 in the connection zone 5 are welded to one another over a closed surface in order to keep the electrical contact resistance low.

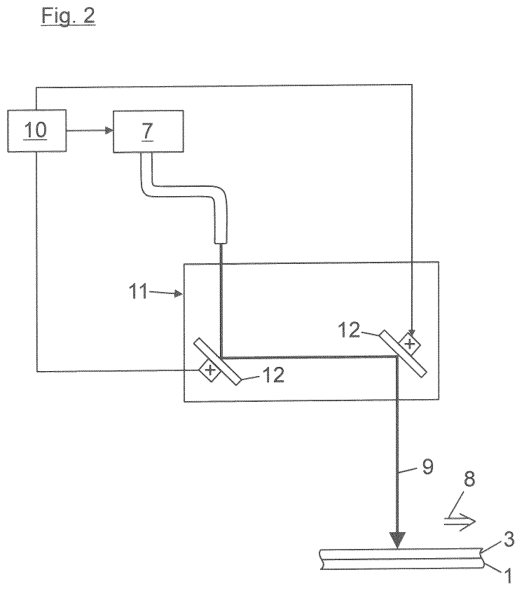

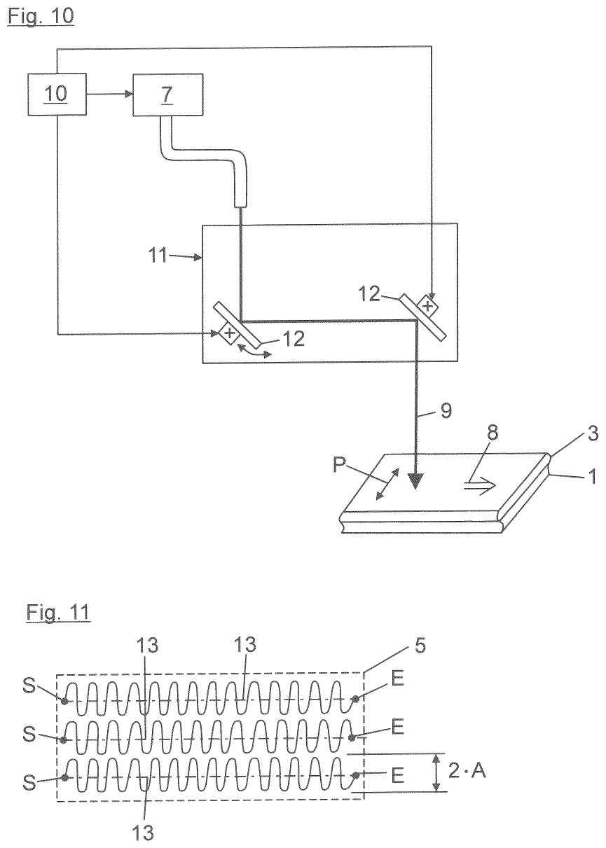

The welded joint shown in FIG. 1 is created by means of the laser welding system indicated in FIG. 2. This is only shown to the extent that it is necessary for understanding the invention. Accordingly, the laser beam welding device has an electronic control unit 10, by means of which a laser beam generation unit 7 can be controlled to generate a laser beam 9. This is fed to a scanner unit 11. During the welding process, the laser beam 9 is guided over the surface of the upper joint partner 3 with the aid of movable or rotatable scanner mirrors 12 of the scanner unit 11. According to the invention, the two scanner mirrors 12 are used only to produce the weld seam path 19. A superimposed laser beam oscillation, as shown in the comparative example of FIGS. 10 and 11, does not occur.

During the welding process, the laser beam 9 moves along a meandering target welding track 13, which is indicated in bold and dash-dotted lines in FIG. 1. The target welding track 13 extends from a starting point S to an end point E. In FIG. 1, the target welding track 13 has five longitudinal track sections 15 lying next to one another, which are connected to one another in series via transverse track sections 17. The transverse track sections 17 are designed in FIG. 1 as rectilinear by way of example, so that a right-angled connection is provided between adjacent longitudinal track sections 15. Alternatively, the transverse track sections 17 can have any other geometry, for example circular or arcuate.

During the welding process, the laser beam 9 moves along the target welding track 13, whereby a corresponding welding seam path 19 is formed, which has a predefined welding depth t and a predefined seam width b. The adjacent path sections of the weld seam path 19 form the closed-surface connection zone 5, which is indicated in FIG. 1 with a dashed line. According to FIG. 1, the track spacing a between adjacent longitudinal track sections 15 is set such that corresponding track sections of the weld seam path 19 formed in the welding process overlap with a lap amount Δm. As an alternative to FIG. 1, the lap amount Δm can also be zero (Δm=0). In this case, the adjacent path sections of the weld seam path 19 merge into one another without overlapping. In a further alternative, the adjacent path sections of the weld seam path 19 can also be arranged with a path spacing from each other (Δm<0).

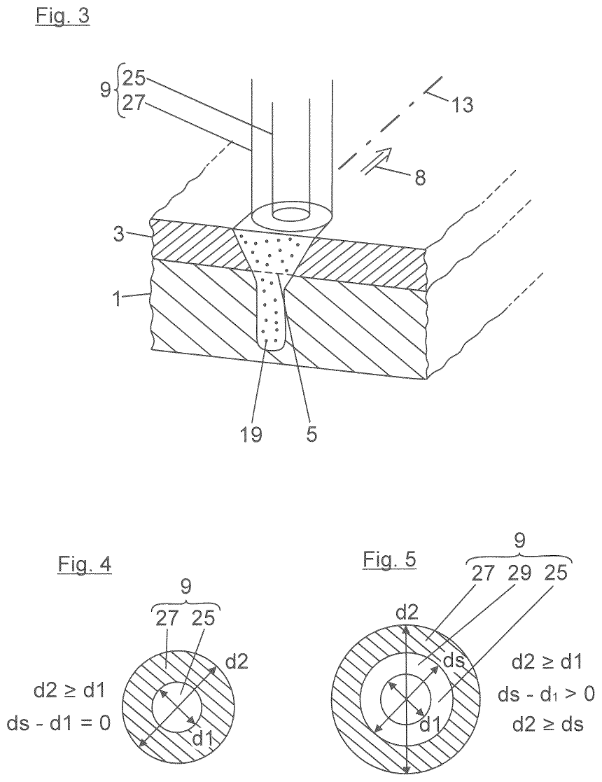

In FIG. 1, the laser beam welding device generates a laser beam 9 during the welding process, which forms a circular radiation area 23 (round spot) on the upper joint partner 3. This is located in FIG. 1 at the end point E of the target welding track 13. In contrast, in the laser beam welding system, beam forming can preferably take place via fiber/optical fiber cable, in which the laser beam 9 is divided into at least a first partial beam 25 and a second partial beam 27. As can be seen from FIGS. 3 to 5, the laser beam 9 has, for example, a radially inner core beam as the first partial beam 25 and a radially outer ring beam arranged concentrically with the same center as the second partial beam 27. The power distribution between the core beam 25 and the ring beam 27 is dimensioned such that the welding depth t can be adjusted by means of the core beam 25, while the seam width b can be adjusted by means of the radially outer ring beam 27.

In an exemplary weld seam formation shown in FIG. 3, the power ratio is 40% in the core and 60% in the ring with a diameter ratio d2/d1 of 4. The feed rate in process direction 8 is 500 mm/s with a laser power of 5.5 kW.

Examples of beam forming in the glass fiber are fibers with a concentric arrangement without or with a geometric distance (annular gap) between core and ring. Variable values in this case are, in the case of concentric arrangement, the diameter ratio d2/d1, wherein d2≥d1 (d2: ring outer diameter ring, d1: core outer diameter) FIG. 4 shows the condition for the geometric distance ds−d1=0. This is therefore not present and appears in fibers with a refractive index difference in the interface. In FIG. 5, the geometric distance 29 is described with ds-d1>0 and d2≥ds. In case d2=ds there is a simple round spot, as in FIG. 4, provided d1=d2.

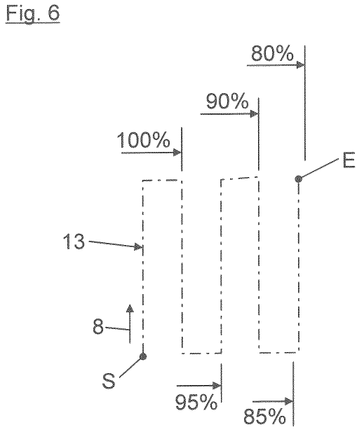

FIG. 6 shows a further embodiment in which only the target welding track 13 for producing the closed-surface connection zone 5 according to FIG. 1 is indicated in isolation. A laser beam 9 (not shown) with a core beam 25 and a concentric ring beam 27 or alternatively a round beam moves along the target welding track 13. In a welding process with a consistently constant laser power between the starting point S and the end point E, a heat field can form, which leads to a corresponding heat accumulation. The preheating can lead to a disadvantageously large welding depth t when crossing a subsequent longitudinal track section 15. In order to counteract such a heat build-up-related increase in the welding depth t as well as a simultaneous increase in the process temperature in the welded joint, the following measure is taken in FIG. 6: The laser beam power is gradually reduced during the laser beam passage in the order from the first (left) longitudinal track section 15 to the last (right) longitudinal track section 15, for example by a predefined amount of 5% per longitudinal track section 15. For example, in FIG. 6, when the laser beam passes over the first longitudinal track section 15, the laser beam power is still 100%. When crossing the second to fifth longitudinal track sections 15, the laser beam power is reduced by 5% each time, so that when the laser beam crosses the last (right) longitudinal track section 15, the laser beam power is 80%.

In FIG. 6, for example, the laser power is abruptly reduced in the corners by 5% relative to the maximum power of the first longitudinal track section 15 for each additional longitudinal track section 15. In addition to a sudden reduction in laser power at one point, the power reduction can also be achieved via preferably linear power ramps between the power levels. The connecting section (transverse track sections 17) between the longitudinal track sections 15 is preferably used for this purpose. However, the length of the power ramp is not limited to this length.

There are also no limits to the design of the weld seam geometry due to the flexibility of the scanner. Examples of the resulting weld seam geometry in the case of high-voltage battery cell contacts are shown in the following FIGS. 7 to 9. In FIGS. 7 to 9, target welding tracks 13 are shown in different geometric shapes. According to FIG. 7, the target welding track 13 has a spiral shape, in which the target welding track 13 extends from a radially inner starting point S in a counterclockwise spiral outwards, with a circular movement sequence with a continuously increasing movement radius r. In FIG. 7, the numbers in brackets (1-9) symbolize switching points for the laser power. If the laser beam passes over the entire spiral with constant power, the welding depth t increases radially outwards. If, however, the power is reduced in sections, a constant welding depth t results over the entire weld geometry.

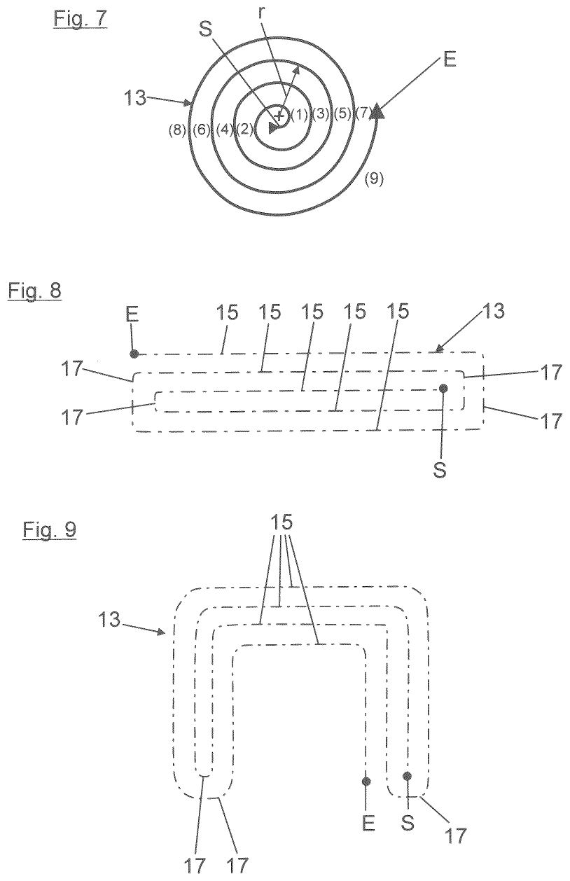

Alternatively, in FIG. 8, the target welding track 13 is designed in a mixture of spiral shape and meander shape, namely with the formation of a radially inner longitudinal track section 15 and further longitudinal track sections 15 arranged parallel on both sides thereof. All longitudinal track sections 15 are connected to one another in a spiral shape via transverse track sections 17. The target welding track 13 shown in FIG. 8 has a total of five longitudinal track sections 15. According to FIG. 8, the target welding track 13 is guided from a radially inner starting point S (as in FIG. 7) in a counterclockwise spiral outwards to the end point E.

The target welding track 13 shown in FIG. 9 is made up of a total of four longitudinal track sections 15. Instead of a right-angled transverse line connection between the longitudinal track sections 15, the transverse track sections 17 in FIG. 9 run in a circular or arcuate manner. This allows a more precise maintenance of the path speed of the laser beam 9 and is preferable to a right-angled transfer. Accordingly, the previously mentioned power ramp can also be transferred to the circular path. For a controlled start and end of the process, a superimposed power ramp is recommended.

In FIG. 9, the intended closed-surface connection zone 5 is not to be formed as a rectangular surface, but rather as an example as a U-profile-shaped surface. Accordingly, the target welding track 13 has an inner longitudinal track section 15 as well as longitudinal track sections 15 arranged parallel to both sides thereof. In contrast to FIG. 8, in FIG. 9 the longitudinal track sections 15 are angled twice by 90° in order to create the U-shaped connection zone 5. According to FIG. 9, the target welding track 13 is guided from a radially inner starting point S (as in FIG. 7 or 8) in a counterclockwise spiral outwards to the end point E.

In FIGS. 7 to 9, the starting points S of the target welding track 13 are located, for example, in the interior of the welding track geometry and the target welding track 13 is guided outwards in a counterclockwise direction. Alternatively, the target welding track 13 can also extend clockwise from the starting point S. As a further alternative—depending on the target heat propagation—the end point E can also be located inside the welding track geometry, while the starting point S is outside.

The invention is not limited to a specific surface geometry of the connection zone 5. As an alternative to FIG. 9, the connection zone 5 can also have, for example, an annular surface geometry.

A core of the invention is that the laser beam 9 is guided along the target welding track 13 in the welding process without oscillating pendulum movement P (FIG. 11). The path covered by the laser beam 9 on the joint partner surface therefore corresponds to the length of the target welding track 13.

In contrast, FIGS. 10 and 11 show a comparative example not covered by the invention. The basic structure and the functioning of the laser beam welding device shown in FIG. 10 corresponds to the structure and the functioning of the laser beam welding device shown in FIG. 2. Therefore, reference is made to the previous description.

The formation of the closed-surface connection zone 5 indicated in FIG. 11 between the joint partners 1, 3 takes place by means of a path planning strategy not covered by the invention: Accordingly, the connection zone 5 (indicated in FIG. 11 with a dashed line) has a total of three target welding tracks 13, which are separate from one another and parallel to one another. Each of the three target welding tracks 13 is guided by the laser beam 9 in a separate laser beam pass from the respective starting point S to the respective end point E. In addition, each laser beam pass is superimposed by a lateral spatial laser beam oscillation (can also be any other form of oscillation), in which the laser beam 9 is deflected in an oscillating pendulum motion P (FIG. 11) around the respective target welding track 13 with an amplitude A (FIG. 11) transverse to the target welding line 13. The path covered by the laser beam 9 is therefore considerably greater than the actual length of the respective target welding track 13.

During laser beam oscillation, the processing optics must usually follow, by means of scanner mirrors 12, a frequency and amplitude A adapted to the feed rate in order to generate a closed connection surface or connection zone 5. Due to the inertia of the moving masses of the scanner mirrors 12 and the functioning of the drive motors, the amplitude A cannot be reached anymore when the feed speed and thus the scan frequency is increasing. Consequently, the achievable seam width in the joint plane decreases with the amplitude and the requirements for electrical resistance and strength are no longer guaranteed.

### LIST OF REFERENCE NUMERALS

1,3 joint partner
5 closed-surface connection zone
7 laser beam generation unit
8 process direction
9 laser beam
10 control unit
11 scanner unit
12 scanner mirror
13 target welding track
15 longitudinal track section
17 transverse track section
19 weld seam path
23 radiation circular surface
25 first partial beam, for example core beam
27 second partial beam, for example ring beam
29 ring gap or distance
a track spacing
Δm lap amount
b seam width
S starting point
E end point
r radius of movement
t welding depth
P pendulum movement
A amplitude

1-10. (canceled)

11. A method for laser beam welding at least two joint partners which are placed one above the other in an lap joint, wherein the two joint partners are welded to one another by a linear seam to form a preferably closed-surface connection zone, wherein to form the connection zone, the laser beam is guided in the welding process according to any path planning strategy along a target welding track, specifically to form a weld seam path, the adjacent path sections of which build up the preferably closed-surface connection zone, and in particular in that the welding process is carried out using a path planning strategy in which the laser beam is guided along a meandering and/or spiral-shaped target welding track.

12. The method according to claim 11, wherein the connection zone is formed with exactly one continuous weld seam path, which preferably extends uninterruptedly along the entire target welding track.

13. The method according to claim 11, wherein the laser beam is guided along the target welding track in the welding process without oscillating pendulum movement (P), so that the path covered by the laser beam on one of the joint partner surfaces corresponds to the length of the target welding track.

14. The method according to claim 11, wherein the track spacing (a) between adjacent track sections of the target welding track is set such that the corresponding track sections of the weld seam path formed in the welding process overlap with a lap amount (Δm), or alternatively in that the lap amount (Δm) is zero (Δm=0), so that the adjacent track sections of the weld seam path merge into one another without overlapping, or alternatively in that the adjacent path sections of the weld seam path are arranged with a track spacing from one another (Δm<0).

15. The method according to claim 11, wherein, in order to increase the seam width (b) on the weld seam path surface, beam forming is carried out in which the laser beam is divided into at least a first partial beam and a second partial beam.

16. The method according to claim 15, wherein by the beam forming a radially inner core beam and a radially outer ring beam concentric therewith with or without an intermediate geometric gap are generated, and in that in particular the power distribution between the core and ring beam is dimensioned such that the welding depth (t) can be adjusted by means of the core beam and the seam width (b) can be adjusted by means of the ring beam.

17. The method according to claim 11, wherein in the welding process, as the process duration progresses, the laser beam power is deliberately reduced during the construction of the closed-surface connection zone in order to counteract an increase in the welding depth (t) and the process temperature due to heat build-up, and in that, in particular during the formation of each adjacent path section of the weld seam path, the laser beam power is reduced by an amount.

18. The method according to claim 11, wherein in order to form the closed-surface connection zone, the target welding track is designed in a meandering manner with mutually parallel longitudinal track sections which are connected to one another in series via transverse track sections, and in that, in particular in the welding process, the laser beam power is reduced by an amount per longitudinal track section during the laser beam passage in the order from the first to the last longitudinal track section.

19. The method according to claim 11, wherein in order to form the closed-surface connection zone, the target welding track has a spiral shape in which the target welding track extends from a radially inner starting point(S) in a spiral radially outward direction, in a circular movement sequence with a continuously increasing radius of movement (r), or the target welding track extends from a radially outer starting point(S) in a spiral radially inward direction, in a circular movement sequence with a continuously decreasing radius of movement (r).

20. The method according to claim 11, wherein in order to form the closed-surface connection zone, the target welding track is designed in a mixture of spiral shape and meander shape, namely with the formation of a radially inner longitudinal track section and further longitudinal track sections arranged parallel on both sides thereof, all of which are connected to one another in a spiral shape via transverse track sections.

21. The method according to claim 12, wherein the laser beam is guided along the target welding track in the welding process without oscillating pendulum movement (P), so that the path covered by the laser beam on one of the joint partner surfaces corresponds to the length of the target welding track.

22. The method according to claim 12, wherein the track spacing (a) between adjacent track sections of the target welding track is set such that the corresponding track sections of the weld seam path formed in the welding process overlap with a lap amount (Δm), or alternatively in that the lap amount (Δm) is zero (Δm=0), so that the adjacent track sections of the weld seam path merge into one another without overlapping, or alternatively in that the adjacent path sections of the weld seam path are arranged with a track spacing from one another (Δm<0).

23. The method according to claim 13, wherein the track spacing (a) between adjacent track sections of the target welding track is set such that the corresponding track sections of the weld seam path formed in the welding process overlap with a lap amount (Δm), or alternatively in that the lap amount (Δm) is zero (Δm=0), so that the adjacent track sections of the weld seam path merge into one another without overlapping, or alternatively in that the adjacent path sections of the weld seam path are arranged with a track spacing from one another (Δm<0).

24. The method according to claim 12, wherein, in order to increase the seam width (b) on the weld seam path surface, beam forming is carried out in which the laser beam is divided into at least a first partial beam and a second partial beam.

25. The method according to claim 13, wherein, in order to increase the seam width (b) on the weld seam path surface, beam forming is carried out in which the laser beam is divided into at least a first partial beam and a second partial beam.

26. The method according to claim 14, wherein, in order to increase the seam width (b) on the weld seam path surface, beam forming is carried out in which the laser beam is divided into at least a first partial beam and a second partial beam.

27. The method according to claim 12, wherein in the welding process, as the process duration progresses, the laser beam power is deliberately reduced during the construction of the closed-surface connection zone in order to counteract an increase in the welding depth (t) and the process temperature due to heat build-up, and in that, in particular during the formation of each adjacent path section of the weld seam path, the laser beam power is reduced by an amount.

28. The method according to claim 13, wherein in the welding process, as the process duration progresses, the laser beam power is deliberately reduced during the construction of the closed-surface connection zone in order to counteract an increase in the welding depth (t) and the process temperature due to heat build-up, and in that, in particular during the formation of each adjacent path section of the weld seam path, the laser beam power is reduced by an amount.

29. The method according to claim 14, wherein in the welding process, as the process duration progresses, the laser beam power is deliberately reduced during the construction of the closed-surface connection zone in order to counteract an increase in the welding depth (t) and the process temperature due to heat build-up, and in that, in particular during the formation of each adjacent path section of the weld seam path, the laser beam power is reduced by an amount.

30. The method according to claim 15, wherein in the welding process, as the process duration progresses, the laser beam power is deliberately reduced during the construction of the closed-surface connection zone in order to counteract an increase in the welding depth (t) and the process temperature due to heat build-up, and in that, in particular during the formation of each adjacent path section of the weld seam path, the laser beam power is reduced by an amount.
